(19) United States
(12) Patent Application Publication
(10) Pub. No.: US 2023/0085867 A1
(43) Pub. Date: Mar. 23, 2023

(54) METHODS OF TRAINING DEEP NEURAL NETWORKS (DNN) USING SIGNAL NON-IDEALITIES AND QUANTIZATION ASSOCIATED WITH IN-MEMORY OPERATIONS AND RELATED DEVICES

(71) Applicant: Arizona Board of Regents of behalf of Arizona State University, Scottsdale, AZ (US)

(72) Inventors: Adnan Siraj Rakin, Tempe, AZ (US); Deliang Fan, Tempe, AZ (US); Sai Kiran Cherupally, Tempe, AZ (US); Jae-sun Seo, Tempe, AZ (US)

(21) Appl. No.: 17/931,682

(22) Filed: Sep. 13, 2022

Related U.S. Application Data
(60) Provisional application No. 63/243,452, filed on Sep. 13, 2021.

(51) Int. Cl. G06F 21/64; G06N 3/063

(52) U.S. Cl. CPC G06F 21/64; G06N 3/063

(57) ABSTRACT

Method, systems, and devices, disclosed herein can leverage noise and aggressive quantization of in-memory computing (IMC) to provide robust deep neural network (DNN) hardware against adversarial input and weight attacks. IMC substantially improves the energy efficiency of DNN hardware by activating many rows together and performing analog computing. The noisy analog IMC induces some amount of accuracy drop in hardware acceleration, which is generally considered as a negative effect. However, this disclosure demonstrates that such hardware intrinsic noise can, on the contrary, play a positive role in enhancing adversarial robustness. To achieve this, a new DNN training scheme is proposed that integrates measured IMC hardware noise and aggressive partial sum quantization at the IMC crossbar. It is shown that this effectively improves the robustness of IMC DNN hardware against both adversarial input and weight attacks.

### CLAIM FOR PRIORITY

The present application claims priority to U.S. Provisional Patent Application No. 63/243,452 titled LEVERAGING NOISE AND AGGRESSIVE QUANTIZATION OF IN-MEMORY COMPUTING FOR ROBUST DNN HARDWARE AGAINST ADVERSARIAL INPUT AND WEIGHT ATTACKS, filed on Sep. 13, 2021, in the U.S.P.T.O., the entirety of which is hereby incorporated herein by reference.

### STATEMENT OF GOVERNMENT SUPPORT

This invention was made with government support under 1652866, 1715443, 2005209 and 2019548 awarded by the National Science Foundation and under HR0011-18-3-0004 awarded by the Defense Advanced Research Projects Agency (DARPA). The government has certain rights in the invention.

### FIELD

The present disclosure relates to deep neural networks (DNN), and in particular to protection of DNNs from adversarial attacks.

### BACKGROUND

Deep neural networks (DNNs) have shown substantial success for many practical applications, e.g., image/speech recognition, autonomous driving, etc., achieving high accuracy aided by deep and complex network structures. While many works have investigated DNN model size reduction, DNNs may use significant computation and memory resources. As a means to address such computation/memory challenges, in-memory computing (IMC) has been proposed and has shown promising energy-efficiency numbers. While IMC substantially improves the energy-efficiency of multiply-and-accumulate (MAC) operations in DNNs, the noise margin may be lower due to the analog nature of computing and noise/variability, may lead to accuracy degradation.

On the other hand, the vulnerability of DNNs against adversarial attacks has been an important issue, where adversaries can manipulate the inputs/weights of DNNs by small amounts and reduce the inference accuracy. Some prior work has shown that the performance of DNNs can be degraded by modifying the inputs of DNNs by a small amount using adversarial algorithms such as projected gradient descent (PGD) and fast gradient sign method (FGSM). These algorithms can iteratively analyze the gradients at different locations in the network topology and use DNN optimization functions to identify the suitable magnitude of change in the input pixels, so that the DNN classifies the input incorrectly.

Some work has claimed to provide a robust defense against such attacks, such as PGD, but that robustness may be obtained mainly due to the presence of obfuscated gradients, e.g., in quantized DNNs. Obfuscated gradients, however, can be circumvented using the backward-pass differentiable approximation (BPDA) technique. Hence, DNNs may be vulnerable to adversarial input attacks, even if they are quantized to low precision.

In addition, adversarial weight attacks are known, where the attacker iteratively identifies the most vulnerable bits of the weights in all DNN layers that lead to large accuracy loss. In some cases. the accuracy of 8-bit DNNs may be reduced to below a random guess by only flipping tens of bits in the entire model. These attacks may make the DNN hardware that stores DNN weights and biases vulnerable.

### SUMMARY

Embodiments described herein leverage noise and aggressive quantization of in-memory computing (IMC) to provide robust deep neural network (DNN) hardware against adversarial input and weight attacks. IMC substantially improves the energy efficiency of DNN hardware by activating many rows together and performing analog computing. The noisy analog IMC induces some amount of accuracy drop in hardware acceleration, which is generally considered as a negative effect. However, this disclosure demonstrates that such hardware intrinsic noise can, on the contrary, play a positive role in enhancing adversarial robustness.

To achieve this, a new DNN training scheme is proposed that integrates measured IMC hardware noise and aggressive partial sum quantization at the IMC crossbar. It is shown that this effectively improves the robustness of IMC DNN hardware against both adversarial input and weight attacks. Against black-box adversarial input attacks and bit-flip weight attacks, DNN robustness is improved by up to 10.5% (CIFAR-10 accuracy) and 33.6% (number of bit-flips), respectively, compared to conventional DNNs.

An exemplary embodiment provides a method for strengthening a DNN against adversarial attacks. The method includes providing the DNN on IMC hardware; and training the DNN using measured noise of the IMC hardware.

Another exemplary embodiment provides a robust DNN device. The robust DNN device includes IMC hardware; and a memory storing instructions. The instructions are configured to cause the IMC hardware to: implement the DNN; and train the DNN using measured noise of the IMC hardware.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1A is a schematic diagram of a resistive static random-access memory (SRAM) cells in an XNOR configuration for in-memory computing (IMC) memory operation in support of a DNN.

FIG. 1B illustrates diagram of the resistive SRAM IMC of FIG. 1A.

FIG. 2A is a schematic diagram of a representative capacitive SRAM IMC design.

FIG. 2B illustrates operation of the capacitive SRAM IMC of FIG. 2A.

FIG. 3A is a schematic illustration of methods of training a black-box model for a substitute model attack.

FIG. 3B is a schematic illustration of methods of attacking a target model for the substitute model attack of FIG. 3A.

FIG. 4A is a graphical representation of black-box adversarial accuracy with IMC-noise-aware training based on IMC measurements at 0.6 volts (V) for deep neural networks (DNNs) trained with clean images in some embodiments according to the inventive concept.

FIG. 4B is a graphical representation of black-box adversarial accuracy with IMC-noise-aware adversarial training based on IMC measurements at 0.6 V for DNNs trained with clean and adversarial images in some embodiments according to the inventive concept.

FIG. 5 is a graphical representation of the effect of ideal vs. noisy partial sum quantization (PSQ) during adversarial training on black-box adversarial accuracy for ResNet-18 DNNs in some embodiments according to the inventive concept.

FIG. 6 is a graphical representation of the effect of aggressive PSQ (i.e., input-splitting) and IMC noise on black-box adversarial accuracy for ResNet-18 DNNs with 1-bit, 2-bit, and 4-bit weights and activations in some embodiments according to the inventive concept.

FIG. 7A is a graphical representation of bit-flip attack (BFA) performance of a 1-bit ResNet at different noise levels in some embodiments according to the inventive concept.

FIG. 7B is a graphical representation of BFA performance of a 2-bit ResNet at different noise levels in some embodiments according to the inventive concept.

FIG. 7C is a graphical representation of BFA performance of a 4-bit ResNet at different noise levels in some embodiments according to the inventive concept.

FIG. 8 is a flow diagram illustrating methods for strengthening a DNN against adversarial attacks in some embodiments according to the inventive concept.

FIG. 9 is a block diagram of a computer system suitable for implementing robust DNNs in some embodiments according to the inventive concept.

FIG. 10 is a flow diagram illustrating methods pre-training a DNN against adversarial attacks using measured variations from idealities in signals generated by an in-memory computing crossbar array circuit responsive to the training in some embodiments according to the inventive concept.

FIG. 11 is a schematic illustration of an exemplary an IMC crossbar circuit configured to perform DNN operations in-memory including noisy output signals due to non-idealities such as line resistances in the crossbar in some embodiments according to the inventive concept.

### DETAILED DESCRIPTION OF EMBODIMENTS ACCORDING TO THE INVENTIVE CONCEPT

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that the terms “noise” and “noisy” are used herein to refer to the variations in analog signals generated by in-memory computing crossbar circuits provided due to, for example, variations in the resistances of components included in the in-memory computing crossbar circuit, such as the resistance of bitlines, source lines, which may vary from device to device. Furthermore, the phrase “variation from idealities” can also be used herein to refer to the variations in the analog signals described above.

Embodiments described herein can leverage noise and aggressive quantization of in-memory computing (IMC) to provide deep neural network (DNN) hardware having improved protection against adversarial input and weight attacks. As described herein, IMC can improve the energy efficiency of DNN hardware by activating many rows of data together which can be combined internally (in the IMC crossbar) to provide an analog signal that represents the result of an operation performed within the DNN. The noisy analog signals generated by the IMC crossbar can reduce the accuracy drop of hardware acceleration, which has been generally considered as a negative effect. As appreciated by the present inventors, however, such hardware intrinsic noise can improve the performance of the DNN against an adversarial attack.

In some embodiments according to the inventive concept, a new DNN training scheme is disclosed herein that can integrate measured IMC hardware noise and aggressive partial sum quantization at the IMC crossbar. As described herein, this can effectively improve the robustness of IMC DNN hardware against both adversarial input and weight attacks. For example, in some embodiments according to the inventive concept, against black-box adversarial input attacks and bit-flip weight attacks, DNN robustness can be improved by up to about 10.5% (CIFAR-10 accuracy) and about 33.6% (number of bit-flips), respectively, compared to conventional DNNs.

### I. Introduction

As disclosed herein, the actual measured hardware noise from IMC prototype chips was used towards enhancing the robustness of DNNs against both adversarial input attacks and weight attacks. Using the input-splitting technique, the effect of aggressively quantizing the partial sums obtained from IMC crossbars on the adversarial robustness was also evaluated. For adversarial input attacks, adversarial training was performed with a continually differentiable exponential linear unit (CELU) activation function for DNNs with 1-bit, 2-bit, and 4-bit activation/weight precision values.

All multiply-and-accumulate (MAC) operations in convolution and fully-connected layers of such pre-trained DNN models are mapped with IMC hardware designs for inference. Injecting IMC hardware noise during the DNN training process was also investigated and the adversarial robustness evaluated. For adversarial weight attacks, the effect of IMC hardware noise and aggressive partial sum quantization was evaluated via input-splitting towards the robustness against bit-flip attacks (BFAs).

In some embodiments according to the inventive concept, up to 10% improvement in the classification accuracy was achieved under black-box adversarial attack when IMC hardware noise and adversarial examples were used to train and test DNNs against adversarial inputs. As also disclosed herein, in some embodiments according to the inventive concept, introducing IMC noise into a conventionally trained DNN during inference led to no degradation or even about 2% improvement in adversarial accuracy. Furthermore, the input-split DNNs with aggressive partial sum quantization improved the robustness against BFA by up to about 30% compared to the conventionally trained DNNs.

Accordingly, embodiments according to the inventive concept can provided improved the robustness in the context of Black-box adversarial attacks with IMC noise injection during training and testing of DNNs, improvement by injecting noise from actual IMC prototype chips during DNN training, improvement by using CELU activation function and IMC noise for DNN inference, and improvement by using input-splitting and aggressive partial sum quantization.

### II. In-Memory Computing and Adversarial Attacks

A. SRAM-Based In-Memory Computing Hardware Designs

In IMC systems, DNN weights are stored in a crossbar structure, and analog computation is performed typically by applying activations as the voltage from the row side and accumulating the bitwise multiplication result via analog voltage/current on the column side. The analog voltage/current values are quantized into digital values by analog-to-digital converters (ADCs) at the crossbar periphery. This way, vector-matrix multiplication of activation vectors and the stored weight matrices can be computed in a highly parallel manner without memory operation to read out the weights.

Embodiments according to the invention may be realized with different types of memory architectures including static random-access memory (SRAM)-based IMC and non-volatile memory (NVM)-based IMC, as disclosed herein. In particular, SRAM has a very high on/off ratio and the SRAM IMC scheme can be implemented in CMOS technology. SRAM IMC schemes can be broadly categorized into resistive and capacitive IMC. Resistive IMC uses the resistive pull-down/pull-up of transistors in the SRAM bit-cell, while capacitive IMC employs additional capacitors in the bit-cell to compute MAC operations via capacitive coupling or charge sharing.

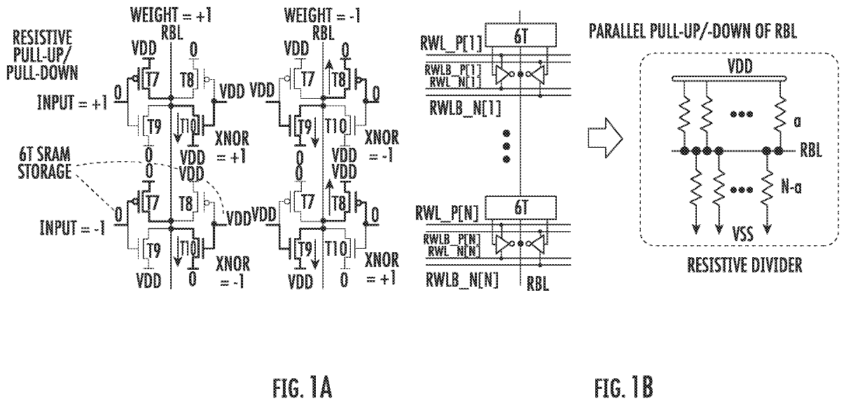

FIG. 1A is a schematic diagram of a representative resistive SRAM IMC design. FIG. 1B illustrates operation of the resistive SRAM IMC of FIG. 1A. In the resistive SRAM IMC, the binary multiplication (XNOR) between activations driving the rows and weights stored in 6T SRAM is implemented by the complimentary pull-up/pull-down circuits of four additional transistors as shown in FIG. 1B.

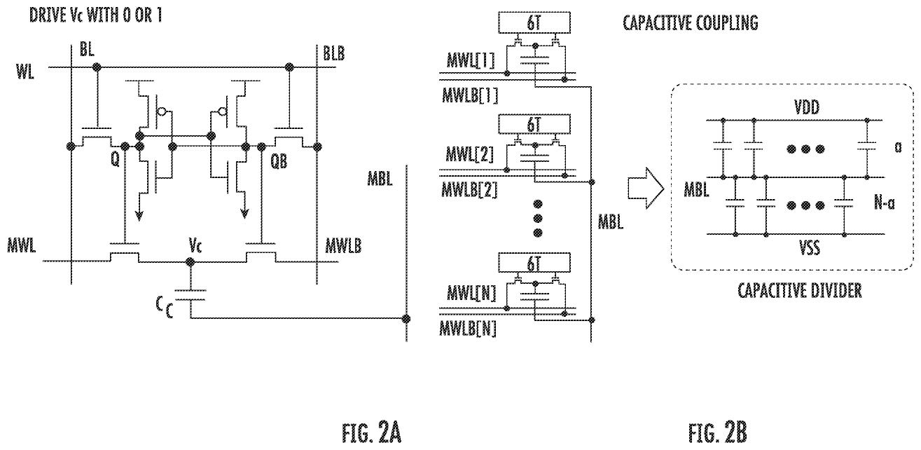

FIG. 2A is a schematic diagram of a representative capacitive SRAM IMC design. FIG. 2B illustrates operation of the capacitive SRAM IMC of FIG. 2A. In the capacitive SRAM IMC, an additional metal-oxide-metal (MOM) capacitor is introduced per bit-cell to perform MAC operations via capacitive coupling. For resistive and capacitive IMC designs, each bit-cell's bitwise multiplication result is accumulated onto the analog bit-line voltage by forming a resistive and a capacitive divider, respectively as shown in FIG. 2B.

B. Adversarial Input and Weight Attacks

The security analysis of DNNs is dominated by the adversarial input noise attack popularly known as adversarial examples attack. Adversarial input attacks can be classified into two major categories: white-box and black-box attacks. In a white-box attack (e.g., PGD, FGSM), the adversary has complete knowledge about DNN inputs, architectures, and gradients. In contrast, the black-box attack (e.g., Substitute) gives the adversary no access to the DNN information, only leveraging input image and output score of the DNN. As described herein, the adversarial example generation techniques used to evaluate embodiments of the present disclosure are briefly introduced.

1. PGD Attack

Projected gradient descent (PGD) is a popular white-box adversarial input attack. It is one of the strongest L_{∞} norm-based attacks that iteratively generates malicious samples \hat{x} from clean (i.e., no noise) samples x with label y. At each iteration t, PGD follows the update rule:

\hat{x}^{t+1}=\hat{x}^{t}+α·sign(∇ₓ [symbol] (ƒ(\hat{x}^{t};θ),y)) Equation 1

where ƒ(;) is the DNN inference function parameterized by θ, α is the step size, and \hat{x}∈[0,1] for normalized input.

A PGD attack generates a universal and strong adversary among the first order approach (i.e., attack relying on only first order gradient information) by adding the gradient sign of the loss function [symbol] with regard to the input x.

2. Substitute Model Attack

Some approaches have demonstrated that non-linear functions of DNNs cause gradient obfuscation (i.e., attacker fails to approximate the true gradient), which causes the white-box attacks to perform poorly. One possible solution to bypass this obfuscation issue is to evaluate defenses against black-box attacks (e.g., substitute model) that do not require any gradient information.

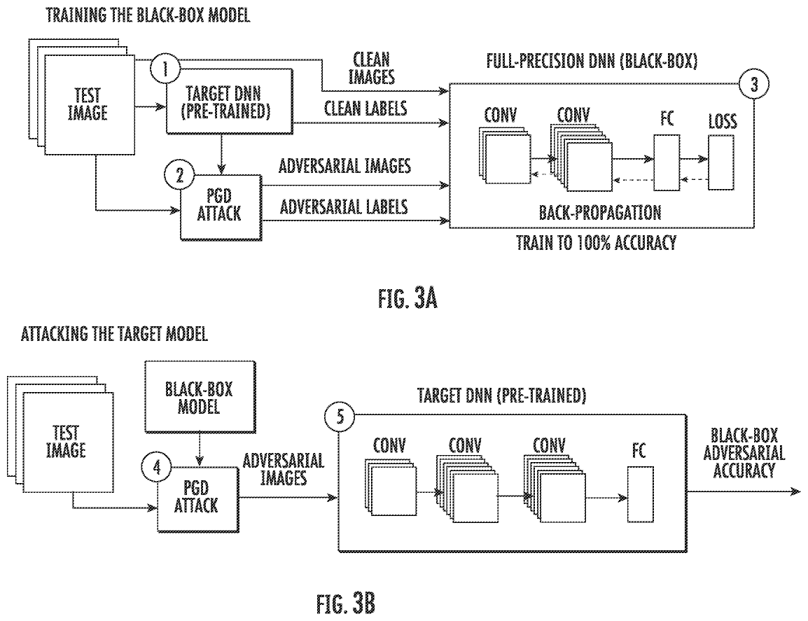

FIG. 3A is a schematic diagram of training a black-box model for a substitute model attack. FIG. 3B is a schematic diagram of attacking a target model for the substitute model attack of FIG. 3A. The adversary can train a substitute model known as a source from the target model to exactly mimic the functionality of the target model. Subsequently, an attacker can use the source model to generate a strong adversary using any white-box attack (e.g., PGD) and transfer the adversary to the target model. FIGS. 3A and 3B illustrate this approach with a PGD attack method.

The vulnerability of DNNs against adversarial weight attacks have also been investigated. Among them, bit flip attack (BFA) has proven to be the most effective, which demonstrated accuracy collapse of ResNet-18 for ImageNet from 69% to 0.1% by modifying only 13 bits out of 88 million bits.

3. Bit-Flip Attack (BFA).

BFA integrates progressive search and gradient ranking to identify the vulnerable bits in quantized DNNs. For each attack iteration, BFA follows two steps: i) In-layer search: The attacker picks each layer of the DNN and flips top n_{b} gradient bits (i.e., n_{b}=1 typically) to record the inference loss. After evaluating the loss, the attacker restores the original bit state. ii) Cross-layer search: In this step, the attacker picks the layer with maximum inference loss evaluated at the last step and performs the bit-flip at that layer. In addition, deep hammer attack has demonstrated that the vulnerable bits identified by BFA can be flipped in real hardware through popular fault injection techniques such as row-hammer. The key advantage of BFA is that quantized networks have been attacked successfully (i.e., lowering accuracy to random guess), whereas other works show unsuccessful weight attack for quantized DNNs.

C. Adversarial Defense with Noise Injection and Quantization

One approach to address the challenge of adversarial examples is to train DNNs using adversarial samples, which is known as adversarial training. This optimizes the network with both clean and malicious samples:

$${arg min}_{θ} \{ {arg max}_{{x}^{′}} ℒ ( f ( \hat{x} ; θ ) , y ) \} \qquad Equation 2$$

Here, the inner maximization generates adversarial samples \hat{x} by maximizing the loss with regard to label y and the outer minimization trains the DNN parameters θ using the adversarial samples forming a min-max optimization problem.

Other approaches perform adversarial training by injecting noise at both training and inference phases. Injecting noise during training works as a regularizer to prevent DNNs from over-fitting and also aids optimization between clean accuracy (i.e., no attack) and perturbed accuracy (i.e., under attack). However, injecting noise during adversarial training causes gradient obfuscation. Other approaches have instead quantized the DNN weights during training to leverage gradient obfuscation only as a defense tool. On the other hand, aggressive model quantization (i.e., binary weights) has been effective in resisting adversarial weight attack (e.g., BFA), but still may not completely defend against this attack.

### III. Adversarial Robustness Schemes Using IMC-Based Noise and Quantization

In some embodiments according to the inventive concept, the inherent noise/variability of IMC hardware and partial sum quantization at the IMC crossbar granularity are exploited to enhance the robustness of DNNs against adversarial attacks. For example, embodiments according to the inventive concept can utilize the following aspects: a PGD based adversarial training (Section TLC) with smooth CELU activation function, in-training activation and weight quantization for low-precision DNNs (e.g., 1-bit, 2-bit, 4-bit), employing IMC noise for DNN inference and training based on actual IMC prototype chip measurements, and using partial sum quantization (e.g., 1-bit, 2-bit, —3-bit) considering IMC crossbar size, ADC, and input-splitting.

A. Adversarial Training with CELU

Several adversarial attacks utilize the gradients of DNNs to generate adversarial images. Accordingly, various functions used in DNNs should be continuously differentiable. While rectified linear unit (ReLU) is one of the commonly used activation functions, the gradient of ReLU has an abrupt change at input of zero. Such a discontinuity lowers the quality of gradients, and weaker adversarial examples would be used for adversarial training of DNNs. To make the gradient continuously differentiable, the CELU activation function is employed, which is defined as:

$$CELU ( x , α ) = \{ \begin{matrix}x , & if x \geq 0 \\ α ( exp ( \frac{x}{α} ) - 1 ) , & otherwise\end{matrix} \qquad Equation 3$$

B. Training DNNs with IMC Quantization and Noise

To train DNNs for inference with very low precision, such as 1-bit, 2-bit, 3-bit, and 4-bit, in-training quantization is used. In IMC hardware targeting low-precision DNN inference, each IMC crossbar performs MAC operations to obtain the partial sum for a fixed number of inputs (e.g., 256-input partial sum), and the partial sums are quantized to a limited number of ADC levels. Due to the hardware noise and variability (e.g., supply noise, mismatch of transistors, wires, and capacitors), the partial sums that have the same MAC value could result in different ADC outputs.

Such hardware noise obtained from IMC prototype chip measurements is employed in two ways. First, noise is only involved for DNN inference for pre-trained 1-bit, 2-bit, and 4-bit DNNs. Second, IMC hardware noise is injected during DNN training at the partial sum level (as measured from the IMC prototype chip), so that DNNs become aware of the noisy quantization of partial sums and adapt the weights accordingly.

C. Aggressive Quantization of Partial Sums in IMC Crossbars

IMC crossbar supports a fixed number of inputs and weights per dot-product computation and generates intermediate analog partial sums. These partial sums are digitized and accumulated outside the IMC crossbar to represent the final output of the layer, also known as a full sum. IMC hardware typically uses multi-bit ADCs to digitize these partial sums performed by a column of the IMC SRAM array, and additional area and energy costs need to be spent to accommodate such ADCs.

The input-splitting scheme is used to address this issue of large ADCs used in IMC hardware. The input-splitting algorithm divides the convolution and fully-connected layers into groups, where each group has the same number of inputs as the IMC crossbar (e.g., 256) and computes partial sums. In some embodiments according to the inventive concept, during the DNN training process, the partial sums are aggressively quantized (e.g., to 1-bit, 2-bit, 3-bit, or 4-bit values), and the DNNs are trained to adapt to such computations. This helps reduce the high-resolution ADCs to single comparators, 2-bit ADCs, or similar low-bit ADCs, but the small adversarial perturbations on inputs or weights of DNNs could be masked by such aggressive partial sum quantization, improving the adversarial robustness.

Table I summarizes the thresholds used in the aggressive partial sum quantization scheme of embodiments described herein:

TABLE I
MAC thresholds and output levels for aggressive
partial sum quantization schemes

| | | |
|---|---|---|
| ADC Precision | MAC Thresholds | MAC Output Levels |

| | | | |
|---|---|---|---|
| 1 | bit | 0 | −1, +1 |
| 2 | bits | −24, 0, +24 | −36, −12, +12, +36 |
| 3.5 | bits | [−54, +54], step = 12 | [−60, +60], step = 12 |

D. Adversarial Input Attack: Black-Box Attack and Evaluation

To circumvent the issue of potential gradient obfuscation present in the low-precision DNNs with IMC noise and partial sum quantization, the black-box adversarial attack as illustrated in FIGS. 3A and 3B can be used.

First, the target DNNs are pre-trained with low-precision and IMC noise (e.g., with gradient obfuscation), and the predicted labels for the clean images are obtained using the pretrained target model. Then, a full-precision black-box DNN (e.g., without gradient obfuscation) is trained using the same input images and corresponding white-box adversarial images obtained from the target model. This black-box model is trained to 100% accuracy with respect to the predicted labels of the target model, and the PGD adversarial attack is applied. Then, the adversarial images generated by the black-box model attack are used to evaluate the adversarial accuracy of the target DNNs with low-precision and IMC noise.

E. Adversarial Weight Attack: Bit Flip Attack and Evaluation

A BFA is performed on DNNs implemented with IMC hardware. The un-targeted BFA uses progressive search and gradient ranking to identify vulnerable bits that degrade test accuracy. The objective of the attacker is to lower the overall test accuracy by maximizing the loss function:

$$max ℒ = {max}_{\{ \hat{W} \}} {𝔼}_{𝕏} ℒ ( f ( x , \hat{W} ) ; t ) \qquad Equation 4$$

where Ŵ is the weight matrix after flipping the target bits, and ƒ(⋅) is the DNN inference function with loss [symbol] . To conduct the attack, the attacker is assumed to have access to a sample batch of data x and corresponding true label t.

To progressively search for vulnerable bits, at each attack iteration, the top n_{b} ranked bits (e.g., typically n_{b}=1) are flipped based on the gradient of every bit in each of the P layers of the DNN. The bits are only flipped in the direction of the gradient sign. After flipping the bits at a given layer, the loss [symbol] is evaluated, and the flipped bits are restored to the original state. This way, a loss profile set of { [symbol] ¹, [symbol] ², . . . , [symbol] ^{p}} is generated, and the layer with maximum loss is identified:

$$j = {arg max}_{l} {\{ {ℒ}^{l} \}}_{l = 1}^{P} \qquad Equation 5$$

Finally, the attacker enters layer j to perform the bit-flip of the current iteration. The attack iterates until DNN accuracy degrades to a random guess (i.e., 10% for CIFAR-10).

### IV. Evaluation

A. Evaluation Setup

Against adversarial attacks, both conventional DNN training and adversarial training are analyzed. The ResNet-18 DNN is primarily used as the target model with 1-bit, 2-bit, and 4-bit precision in activations and weights. Adversarial input and weight attacks are performed, where the PGD algorithm is used as the main adversarial input attack with ∈=0.03, α=2/255, and iterations=10, and the BFA as the main adversarial weight attack. All DNNs were trained using either the Adam or the SGD optimization algorithm in the PyTorch framework.

Starting from the in-training quantization scheme, further modifications are made in the DNN training and inference process to integrate IMC hardware noise injection and input-splitting (1-bit and 2-bit) quantization of partial sums. Adversarial training of DNNs is performed by using both the clean images and corresponding adversarial images obtained using the white-box PGD attack.

DNNs with 1-bit and 2-bit partial sum quantization are also trained by expanding on input-splitting. The ADC comparator thresholds and levels used for 3.5-bit (11-level), 2-bit, and 1-bit partial sum quantization are shown in Table I. Different fixed threshold values were evaluated for DNNs with partial sum quantization, and then the IMC prototype chip was tuned using the best threshold values to extract the IMC hardware noise data.

B. Adversarial Input Attack and Defense Results

Table II shows the clean and black-box adversarial accuracies for binary ResNet-18 trained with IMC noise characteristics measured at different supply voltages. Note that the noise of the resistive SRAM IMC chip increased with higher supply voltages due to larger IR drop on the bit-lines. With a higher amount of IMC noise, the clean accuracy (no attack) slightly degrades, but the adversarial accuracy (black-box attack) notably improved, since injecting a higher amount of noise during DNN training led to a stronger generalization.

TABLE II
Black-box PGD attack accuracies for binary ResNet-18 DNN
with noise-aware training using different noise models

| | | No Adversarial | | PGD Adversarial | |
|---|---|---|---|---|---|
| Noise Model | Relative | Training | | Training | |
| (Training and | Noise | No | BB | No | BB |
| Inference) | Intensity | Attack | Attack | Attack | Attack |
| None | 1 | 89.86% | 24.20% | 86.33% | 34.54% |
| Resistive SRAM | 5.99 | 88.25% | 26.97% | 86.21% | 36.34% |
| IMC 0.6 V | | | | | |
| Resistive SRAM | 12.92 | 87.19% | 29.20% | 85.72% | 37.11% |
| IMC 0.8 V | | | | | |
| Resistive SRAM | 18.62 | 87.19% | 30.12% | 83.46% | 38.63% |
| IMC 1.0 V | | | | | |
| Capacitive | 4.12 | 88.16% | 27.29% | 86.03% | 35.21% |
| SRAM IMC | | | | | |
| PNI Noise | 1.13 | 90.12% | 26.38% | 86.22% | 36.21% |

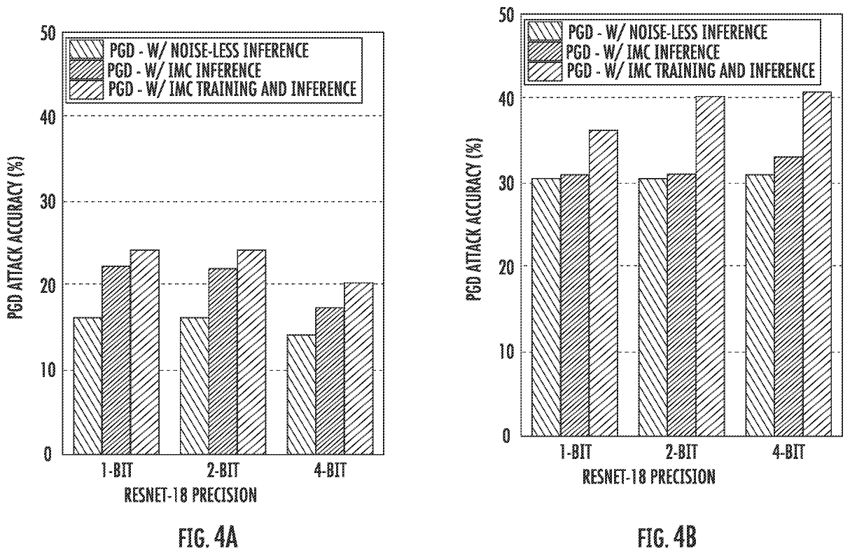

FIG. 4A is a graphical representation of black-box adversarial accuracy with IMC-noise-aware training based on IMC measurements at 0.6 volts (V) for DNNs trained with clean images in some embodiments according to the inventive concept. FIG. 4B is a graphical representation of black-box adversarial accuracy with IMC-noise-aware adversarial training based on IMC measurements at 0.6 V for DNNs trained with clean and adversarial images in some embodiments according to the inventive concept. The effect of adversarial training and IMC-noise-aware training were evaluated on black-box adversarial accuracies for ResNet-18 DNNs with 1-bit, 2-bit, and 4-bit activation/weight precision. It can be seen that adding IMC noise to inference and training progressively increases the PGD attack accuracy.

In comparison to the baseline noiseless model, the accuracy is improved by up to about 10% by adding measured IMC noise to the DNN training and inference process. Compared to the conventionally trained DNNs in FIG. 4A, the DNNs with adversarial training in FIG. 4B show largely improved robustness across all DNNs. The noisy partial sum quantization of IMC noise acts as an inherent regularizer and teaches the DNN to be more tolerant to fluctuations in the partial sum values. Therefore, with IMC-noise-aware training, the DNN becomes more robust against adversarial attacks that perturb the input signal by a small amount.

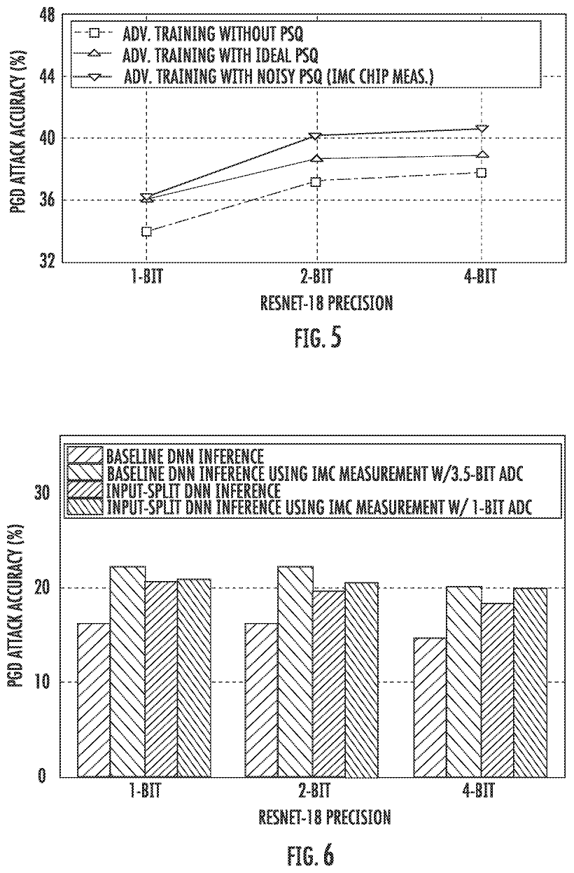

FIG. 5 is a graphical representation of the effect of ideal vs. noisy partial sum quantization (PSQ) during adversarial training on black-box adversarial accuracy for ResNet-18 DNNs in some embodiments according to the inventive concept. The 3.5-bit PSQ for IMC inference was evaluated during the adversarial training of DNNs. Adding IMC noise during training gives the best robustness accuracy results. With IMC-noise-aware training, the black-box adversarial accuracy is improved by up to 7% on average across 5 runs of PGD attacks, compared to adversarial training without IMC noise.

FIG. 6 is a graphical representation of the effect of aggressive PSQ (i.e., input-splitting) and IMC noise on black-box adversarial accuracy for ResNet-18 DNNs with 1-bit, 2-bit, and 4-bit weights and activations in some embodiments according to the inventive concept. The black-box attack accuracies are shown for ResNet-18 DNNs without adversarial training. During training of the same DNNs, the 256-input partial sums are aggressively quantized (fitting the IMC crossbar size) to binary values, which resulted in ˜3% clean accuracy degradation. Aided by input-split DNN training and IMC hardware noise, however, the adversarial attack accuracy improved by up to about 4.77%, about 4.28%, and about 5.74% for 1-bit, 2-bit, and 4-bit ResNet-18 DNNs, respectively.

C. Adversarial Weight Attack and Defense Results

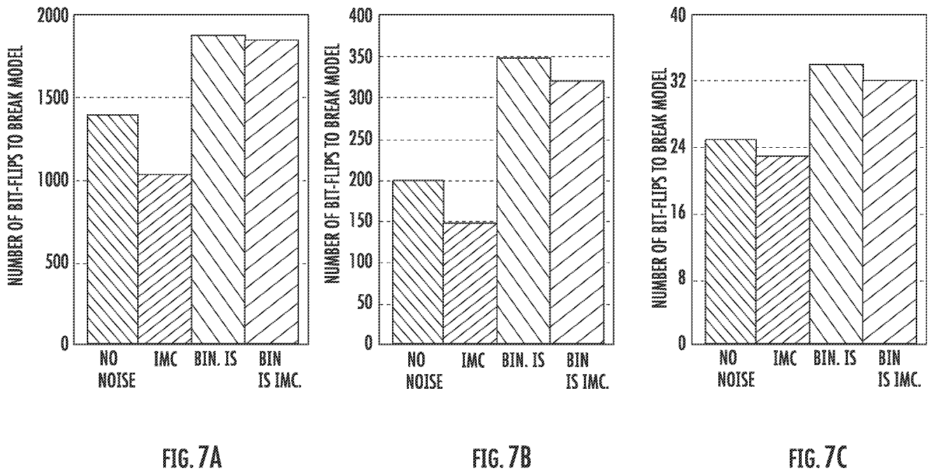

FIG. 7A is a graphical representation of BFA performance of a 1-bit ResNet at different noise levels in some embodiments according to the inventive concept. FIG. 7B is a graphical representation of BFA performance of a 2-bit ResNet at different noise levels. FIG. 7C is a graphical representation of BFA performance of a 4-bit ResNet at different noise levels in some embodiments according to the inventive concept. The different noise levels include no noise, IMC noise measured using 3.5-bit ADC (shown as “IMC”), binary input-split DNN model (shown as “Bin. IS”), and measured binary input-split DNN with IMC noise (shown as “Bin. IS IMC”). BFA was performed for 1-bit, 2-bit, and 4-bit ResNet DNNs for CIFAR-10.

Compared to the baseline BFA (no noise), when the resistive SRAM IMC noise results from 3.5-bit ADC were applied, the DNNs became more vulnerable to BFA (requiring fewer bits to reach about 10% CIFAR-10 accuracy). However, the input-splitting scheme with partial sum binarization required BFA to flip about 33.57% more bits to reach random guess, showing enhanced robustness against BFA. When IMC chip measurements with partial sum binarization with 1-bit ADC (single comparator) were used, a similar level of robustness was maintained against BFA, overall requiring >30% more bit-flips compared to the baseline BFA. It will be understood that binary DNNs can require about 6× to about 50× more bit-flips, compared to 2-bit and 4-bit DNNs, respectively.

D. Comparison to Other Approaches

In Table III, the comparison to two relevant prior works is shown. Compared to PNI (as described in Z. He et al., “Parametric Noise Injection: Trainable Randomness to Improve Deep Neural Network Robustness Against Adversarial Attack,” in IEEE CVPR, 2019), this work can incorporate arbitrary IMC hardware noise and achieves better black-box adversarial accuracy improvement. Roy (as described in D. Roy et al., “Robustness Hidden in Plain Sight: Can Analog Computing Defend Against Adversarial Attacks?” arXiv:2008.1201, 2020) evaluated NVM IMC for different array sizes, but only used ideal simulation models and is not based on actual IMC silicon results. By integrating actual IMC prototype chip results in the DNN training/inference process, the scheme according to embodiments described herein shows better adversarial robustness. In addition, this is the only work that has investigated both adversarial input attacks and weight attacks.

TABLE III
Comparison to other approaches

| Parameter | PNI | Roy | This work |
|---|---|---|---|
| IMC type | N/A | NVM | SRAM chip |
| | | simulation | measurements |
| Array size | N/A | 64 × 64 | 256 × 64 |
| Quantization | Activations | Activation | Activations |
| | Weights | only | Weights |
| Adversarial Training | Yes | No | Yes |
| White-box Adv. Accuracy | N/A | 2.16% | 2.77% |
| Improvement | | | |
| Black-box Adv. Accuracy | 9.83% | 7.80% | 10.52% |
| Improvement | | | |

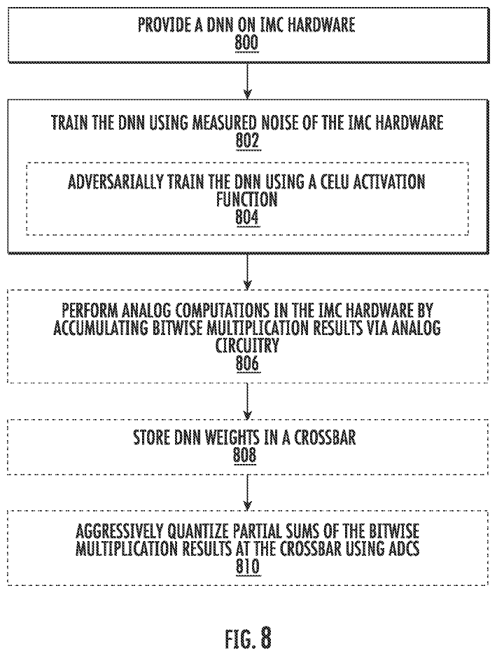

FIG. 8 is a flow diagram illustrating a process for strengthening a DNN against adversarial attacks in some embodiments according to the inventive concept. Dashed boxes represent optional steps. The process begins at operation 800, with providing a DNN on IMC hardware. In an exemplary aspect, the DNN is provided on SRAM-based IMC hardware (e.g., resistive or capacitive). In another aspect, the DNN is provided on NVM-based IMC hardware. The process continues at operation 802, with training the DNN using measured noise of the IMC hardware. Operation 802 (training the IMC hardware) may optionally include operation 804, with adversarial training of the DNN using a CELU activation function.

The process may optionally continue at operation 806, with performing analog computations in the IMC hardware by accumulating bitwise multiplication results via analog circuitry. The process may optionally continue at operation 808, with storing DNN weights in a crossbar. The process may optionally continue at operation 810, with aggressively (e.g., between 1 and 4 bits) quantizing partial sums of the bitwise multiplication results at the crossbar using ADCs (e.g., 1-bit, 2-bit, 3-bit, or 4-bit ADCs).

Although the operations of FIG. 8 are illustrated in a series, this is for illustrative purposes and the operations are not necessarily order dependent. Some operations may be performed in a different order than that presented. For example, operations 806, 808, and 810 may be performed during operation 802 (training the IMC hardware) and/or after operation 802, and may be performed concurrently and/or in a different order. Further, processes within the scope of this disclosure may include fewer or more steps than those illustrated in FIG. 8.

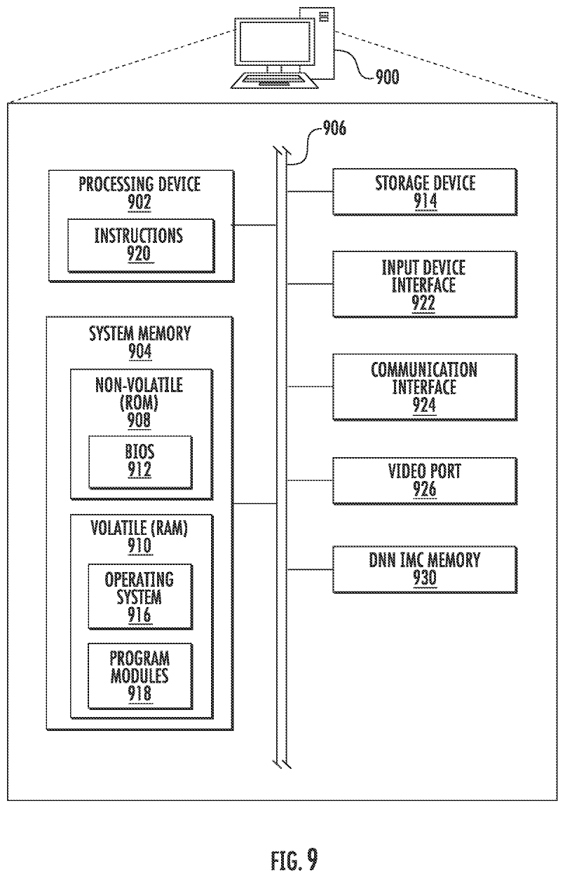

FIG. 9 is a block diagram of a computer system 900 suitable for implementing robust DNNs according to embodiments disclosed herein. Such DNNs may be implemented on the computer system 900, which comprises any computing or electronic device capable of including firmware, hardware, and/or executing software instructions that could be used to perform any of the methods or functions described above, such as strengthening a DNN against adversarial attacks. In this regard, the computer system 900 may be a circuit or circuits included in an electronic board card, such as a printed circuit board (PCB), a server, a personal computer, a desktop computer, a laptop computer, an array of computers, a personal digital assistant (PDA), a computing pad, a mobile device, or any other device, and may represent, for example, a server or a user's computer.

The exemplary computer system 900 in this embodiment includes a processing device 902 or processor, a system memory 904, and a system bus 906. The system memory 904 may include non-volatile memory 908 and volatile memory 910. The non-volatile memory 908 may include read-only memory (ROM), erasable programmable read-only memory (EPROM), electrically erasable programmable read-only memory (EEPROM), and the like. The volatile memory 910 generally includes random-access memory (RAM) (e.g., dynamic random-access memory (DRAM), such as synchronous DRAM (SDRAM)). A basic input/output system (BIOS) 912 may be stored in the non-volatile memory 908 and can include the basic routines that help to transfer information between elements within the computer system 900.

The system bus 906 provides an interface for system components including, but not limited to, the system memory 904 and the processing device 902. The system bus 906 may be any of several types of bus structures that may further interconnect to a memory bus (with or without a memory controller), a peripheral bus, and/or a local bus using any of a variety of commercially available bus architectures.

The processing device 902 represents one or more commercially available or proprietary general-purpose processing devices, such as a microprocessor, central processing unit (CPU), or the like. More particularly, the processing device 902 may be a complex instruction set computing (CISC) microprocessor, a reduced instruction set computing (RISC) microprocessor, a very long instruction word (VLIW) microprocessor, a processor implementing other instruction sets, or other processors implementing a combination of instruction sets. The processing device 902 is configured to execute processing logic instructions for performing the operations and steps discussed herein.

In this regard, the various illustrative logical blocks, modules, and circuits described in connection with the embodiments disclosed herein may be implemented or performed with the processing device 902, which may be a microprocessor, field programmable gate array (FPGA), a digital signal processor (DSP), an application-specific integrated circuit (ASIC), or other programmable logic device, a discrete gate or transistor logic, discrete hardware components, or any combination thereof designed to perform the functions described herein. Furthermore, the processing device 902 may be a microprocessor, or may be any conventional processor, controller, microcontroller, or state machine. The processing device 902 may also be implemented as a combination of computing devices (e.g., a combination of a DSP and a microprocessor, a plurality of microprocessors, one or more microprocessors in conjunction with a DSP core, or any other such configuration).

The computer system 900 may further include or be coupled to a non-transitory computer-readable storage medium, such as a storage device 914, which may represent an internal or external hard disk drive (HDD), flash memory, or the like. The storage device 914 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as optical disks, magnetic cassettes, flash memory cards, cartridges, and the like, may also be used in the operating environment, and, further, that any such media may contain computer-executable instructions for performing novel methods of the disclosed embodiments.

An operating system 916 and any number of program modules 918 or other applications can be stored in the volatile memory 910, wherein the program modules 918 represent a wide array of computer-executable instructions corresponding to programs, applications, functions, and the like that may implement the functionality described herein in whole or in part, such as through instructions 920 on the processing device 902. The program modules 918 may also reside on the storage mechanism provided by the storage device 914. As such, all or a portion of the functionality described herein may be implemented as a computer program product stored on a transitory or non-transitory computer-usable or computer-readable storage medium, such as the storage device 914, volatile memory 910, non-volatile memory 908, instructions 920, and the like. The computer program product includes complex programming instructions, such as complex computer-readable program code, to cause the processing device 902 to carry out the steps necessary to implement the functions described herein.

An operator, such as the user, may also be able to enter one or more configuration commands to the computer system 900 through a keyboard, a pointing device such as a mouse, or a touch-sensitive surface, such as the display device, via an input device interface 922 or remotely through a web interface, terminal program, or the like via a communication interface 924. The communication interface 924 may be wired or wireless and facilitate communications with any number of devices via a communications network in a direct or indirect fashion. An output device, such as a display device, can be coupled to the system bus 906 and driven by a video port 926. Additional inputs and outputs to the computer system 900 may be provided through the system bus 906 as appropriate to implement embodiments described herein.

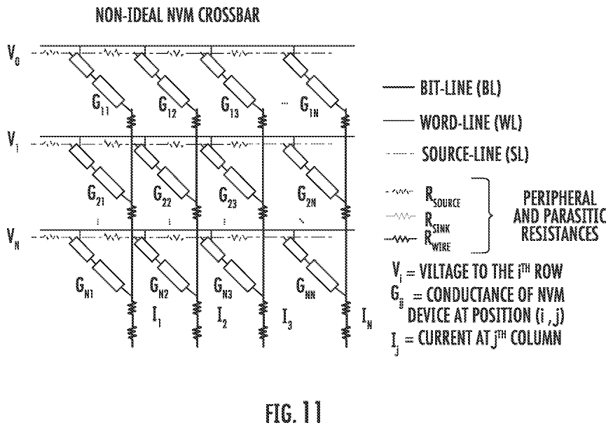

As further shown in FIG. 9, the computer system 900 can include a deep neural network (DNN) IMC memory 930 that can include an in-memory crossbar circuit as described herein and as shown, for example, in FIG. 11. The DNN IMC memory 930 can be operatively coupled to the processing device 902 and can be configured to perform operations of the DNN using the in-memory crossbar circuit.

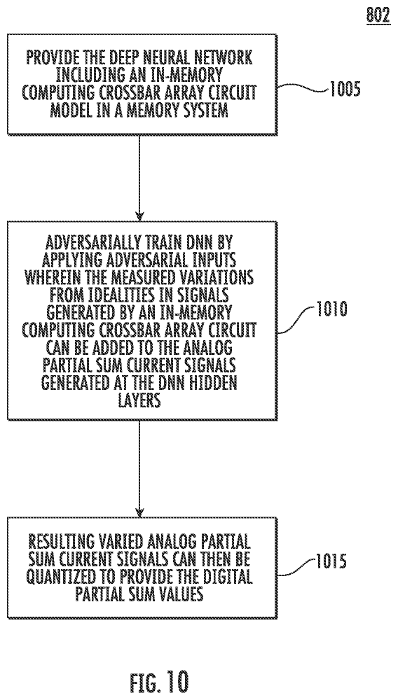

FIG. 10 is a flow diagram illustrating methods pre-training a DNN against adversarial attacks using measured variations from idealities in signals generated by an in-memory computing crossbar array circuit responsive to the training in some embodiments according to the inventive concept. For example, the operations shown in FIG. 10 can provide operation 802 in FIG. 8, in some embodiments according to the inventive concept. According to FIG. 10, a DNN is provided in memory which can also include an in-memory computing crossbar array circuit model at operation 1005, which can be used to incorporate measured variations from idealities in signals generated by an in-memory computing crossbar array circuit. The measured variations can be provided by measuring actual variations (from the ideal) in the analog partial sum current signals generated at the hidden layers of the DNN within an in-memory computing crossbar array circuit. In some embodiments according to the inventive concept, the in-memory computing crossbar array circuit from which the measured actual variations are taken can be the same type of in-memory computing crossbar array circuit used to operate the DNN or a similar in-memory computing crossbar array circuit.

The DNN can be adversarially trained by applying adversarial inputs wherein the measured variations from idealities in signals generated by an in-memory computing crossbar array circuit can be added to the analog partial sum current signals generated at the hidden layers at operation 1010. The resulting varied analog partial sum current signals can then be quantized to provide the digital partial sum values at operation 1015. It will be understood that the varied analog partial sum current signals can be quantized as described herein.

The operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined.

FIG. 11 is a schematic illustration of an exemplary an IMC crossbar circuit configured to perform DNN operations in-memory including noisy output signals due to non-idealities such as line resistances in the crossbar in some embodiments according to the inventive concept. As shown in FIG. 11, the analog partial sum current signals are generated as a product of the input V_{1-N} applied to the source lines and the weights stored in the memory cells. The analog values of the partial sum current signals can vary from ideal values due to, for example, the factors highlighted in FIG. 11.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

The term “about” generally refers to a range of numeric values that one of skill in the art would consider equivalent to the recited numeric value or having the same function or result. For example, “about” may refer to a range that is within ±1%, ±2%, ±5%, ±7%, ±10%, ±15%, or even ±20% of the indicated value, depending upon the numeric values that one of skill in the art would consider equivalent to the recited numeric value or having the same function or result. Furthermore, in some embodiments, a numeric value modified by the term “about” may also include a numeric value that is “exactly” the recited numeric value. In addition, any numeric value presented without modification will be appreciated to include numeric values “about” the recited numeric value, as well as include “exactly” the recited numeric value. Similarly, the term “substantially” means largely, but not wholly, the same form, manner or degree and the particular element will have a range of configurations as a person of ordinary skill in the art would consider as having the same function or result. When a particular element is expressed as an approximation by use of the term “substantially,” it will be understood that the particular element forms another embodiment.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall support claims to any such combination or subcombination.

Those skilled in the art will recognize improvements and modifications to the preferred embodiments of the present disclosure. All such improvements and modifications are considered within the scope of the concepts disclosed herein and the claims that follow.

1. A method for strengthening a deep neural network (DNN) against adversarial attacks, the method comprising:
providing the DNN on in-memory computing (IMC) hardware; and
training the DNN using measured noise of the IMC hardware.

2. The method of claim 1, further comprising performing analog computations in the IMC hardware by accumulating bitwise multiplication results via analog circuitry.

3. The method of claim 2, further comprising:
storing DNN weights in a crossbar; and
quantizing partial sums of the bitwise multiplication results at the crossbar using analog-to-digital converters (ADCs).

4. The method of claim 3, wherein training the DNN further comprises aggressively quantizing the partial sums.

5. The method of claim 4, wherein aggressively quantizing the partial sums comprises quantizing the partial sums to 1-bit, 2-bit, 3-bit, or 4-bit values.

6. The method of claim 4, wherein aggressively quantizing the partial sums comprises quantizing the partial sums to 1-bit or 2-bit values.

7. The method of claim 1, wherein training the DNN further comprises adversarially training the DNN using a continually differentiable exponential linear unit (CELU) activation function.

8.-20. (canceled)

21. A method of training a deep neural network against adversarial attacks, the method comprising:
providing the deep neural network including an in-memory computing crossbar array circuit model in a memory system; and
training the deep neural network using measured variations from idealities in signals generated by an in-memory computing crossbar array circuit responsive to the training to provide a pre-trained deep neural network in the memory system.

22. The method of claim 21 wherein the in-memory computing crossbar array circuit from which the measured variations from idealities in the signals are measured is selected based on the in-memory computing crossbar array circuit model.

23. The method of claim 21 wherein the in-memory computing crossbar array circuit and the in-memory computing crossbar array circuit model include about equal numbers of rows and columns of storage cells.

24. The method of claim 21 wherein the deep neural network includes hidden layers that are configured to be inaccessible from outside the deep neural network, wherein the training comprises:
applying an adversarial input to an input of the deep neural network;
generating analog partial sum current signals at the hidden layers responsive to the adversarial input;
incorporating the measured variations from the idealities into the analog partial sum current signals to provide varied analog partial sum current signals; and
converting the varied analog partial sum current signals to digital partial sum values.

25. The method of claim 24 wherein converting the varied analog partial sum current signals comprises quantizing the varied analog partial sum current signals to less than 5 bits for the digital partial sum values.

26. The method of claim 24 wherein converting the varied analog partial sum current signals comprises quantizing the varied analog partial sum current signals to less than 3 bits for the digital partial sum values.

27. The method of claim 24 wherein converting the varied analog partial sum current signals comprises quantizing the varied analog partial sum current signals to 1 bit for the digital partial sum values.

28. The method of claim 24, wherein generating the analog partial sum current signals at the hidden layers includes a continually differentiable exponential linear unit activation function.

29. A pre-trained deep neural network device, comprising:
a processor device configured to operate a deep neural network that is pre-trained using measured variations from idealities in signals generated by an external in-memory computing crossbar array circuit to provide the pre-trained deep neural network;
a memory system operatively coupled to the processor device, the memory system storing instructions configured to provide operation of the pre-trained deep neural network; and
an in-memory computing memory operatively coupled to the processor device, the memory computing memory including an internal in-memory computing crossbar array circuit.

30. The pre-trained deep neural network device of claim 29 wherein the external in-memory computing crossbar array circuit and the internal in-memory computing crossbar array circuit include about equal numbers of rows and columns of storage cells.

31. The pre-trained deep neural network device of claim 30 wherein the internal in-memory computing crossbar array circuit includes:
quantizing circuits coupled to outputs of the rows and columns of the storage cells, the quantizing circuits configured to quantize analog partial sum current signals from the outputs to less than 5 bits.

32. The pre-trained deep neural network device of claim 30 wherein the internal in-memory computing crossbar array circuit includes:
quantizing circuits coupled to outputs of the rows and columns of the storage cells, the quantizing circuits configured to quantize analog partial sum current signals from the outputs to less than 3 bits.

33. The pre-trained deep neural network device of claim 30 wherein the internal in-memory computing crossbar array circuit includes:
quantizing circuits coupled to outputs of the rows and columns of the storage cells, the quantizing circuits configured to quantize analog partial sum current signals from the outputs to 1 bit.
